(19) United States
(12) Patent Application Publication
(10) Pub. No.: US 2025/0176524 A1
(43) Pub. Date: Jun. 5, 2025

(54) ULTRASOUND CONTROLLED SPOT SPRAYER AND METHODS FOR CROP PROTECTION

(71) Applicant: Martin Perry Heard, Lubbock, TX (US)

(72) Inventor: Martin Perry Heard, Lubbock, TX (US)

(21) Appl. No.: 19/050,443

(22) Filed: Feb. 11, 2025

Related U.S. Application Data
(63) Continuation of application No. PCT/US2023/030085, filed on Aug. 11, 2023.
(60) Provisional application No. 63/397,301, filed on Aug. 11, 2022.

(51) Int. Cl. A01M 7/00

(52) U.S. Cl. CPC A01M 7/0089; A01M 7/0014; A01M 7/006

(57) ABSTRACT

The present invention relates to a novel apparatus for delivering herbicide and/or fertilizer to row crops that includes an array of ultrasound detector pairs that is aligned perpendicular to the row crops, and a sprayer positioned between the ultrasound detectors of each ultrasound detector pair wherein each of the ultrasound detector pairs has a tunable detection window at a desired distance from the sensor.

### BACKGROUND OF THE INVENTION

The present invention relates to a novel apparatus for delivering herbicide to row crops and methods of protecting row crows using the novel apparatus. Current technology for delivering herbicide often lacks precision to distinguish between the crop being protected and the weed. This has led to the need for using selective herbicide, along with crop plants that are genetically engineered to resist the herbicide.

Attempts to apply herbicide in a controlled manner to weeds without exposing the crop plants have encountered difficulties. Existing technology targets weeds as they extend above the top of the row crop, or targets individual plants selectively. This is particularly the case where herbicide is intended for application to weed plants that are taller than the crop plants. There is a need for systems that are simple yet capable of detecting weeds relative to crop plants, and target plants at specific elevations relative to the crop height and delivering herbicide in a controlled manner.

### SUMMARY OF THE INVENTION

The present invention relates to a herbicide spraying apparatus that uses ultrasound detectors that flank both sides of the herbicide spray nozzle in a repeating array, and connected to a controller that is capable of activating the herbicide spray nozzle in response to detection of weeds within a row crop.

In one aspect the invention involves an apparatus for application of herbicide to a row crop comprising: a pair of wheels for translating the apparatus over the row crop that when in use are aligned with the direction of each of a plurality of rows of the row crop;

an array of ultrasound detector pairs arranged perpendicular to the pair of wheels that when is use are aligned perpendicular to the direction of each of the plurality of rows of the row crop; each ultrasound detector pair comprising: a first ultrasound detector in electrical communication with a controller, the first ultrasound detector being capable of detecting a plant within a first predetermined distance range from the sensor; a second ultrasound detector in electrical communication with the controller, the second ultrasound detector being capable of detecting a plant within a second predetermined distance range from the sensor; a spray nozzle, the spray nozzle being positioned between the first ultrasound detector and second ultrasound detector, the spray nozzle being connected to the controller, wherein the spray nozzle is activated through a signal from the controller that is based on detection of a weed by the first ultrasound detector and/or second ultrasound detector.

The apparatus may include a first power supply line connecting a power supply to a relay, and a second power supply line connecting the relay to the spray nozzle. The third power supply line may connect a power supply with the controller and the relay. The first signal wire may connect the first ultrasound detector to the controller, and a second signal wire may connect the second ultrasound detector to the controller.

The apparatus may be configured such that the first predetermined distance range and the second predetermined distance range are the same. The apparatus may also comprise a third ultrasound detector in electrical communication with a controller, the third ultrasound detector being capable of detecting a plant within a third predetermined distance range from the sensor; a fourth ultrasound detector in electrical communication with the controller, the fourth ultrasound detector being capable of detecting a plant within a fourth predetermined distance range from the sensor; a second spray nozzle, the second spray nozzle being positioned between the third ultrasound detector and fourth ultrasound detector, the second spray nozzle being connected to the controller, wherein the second spray nozzle is activated through a signal from the controller that is based on detection of a weed by the third ultrasound detector and/or fourth ultrasound detector. In this case, the third predetermined distance range and the fourth predetermined distance range may be configured to be the same. In one embodiment, the third predetermined distance range and fourth predetermined distance ranges are from 6 inches to 12 inches away from the first sensor and second sensor respectively. The first nozzle and second nozzle may be arranged to be adjacent to each other and the first nozzle during use is positioned between the row crop plants, and the second nozzle may be positioned above the row crop plants.

The invention may further comprise a method involving moving the apparatus described above over a plurality of rows of the row crop. In one aspect, the method may involve arranging the first nozzle and second nozzle to be adjacent to each other with the first nozzle during use being positioned between the row crop plants, and the second nozzle being positioned above the row crop plants.

### BRIEF DESCRIPTION OF THE DRAWINGS

FIG. 1 shows a sprayer in accordance with an embodiment of the invention applying herbicide to weeds.

FIG. 2 shows detail of the spray nozzle and detector layout according to an embodiment of the invention.

FIG. 3 shows a circuit diagram showing connections of the components of the sprayer according to an embodiment of the present invention.

FIG. 4A shows a sprayer apparatus in accordance with one aspect of the invention being used to treat a row crop.

FIG. 4B shows a sprayer apparatus in accordance with another aspect of the invention being used to treat a row crop.

FIG. 5 shows a depiction of an apparatus according to an embodiment of the invention.

### DETAILED DESCRIPTION OF THE INVENTION

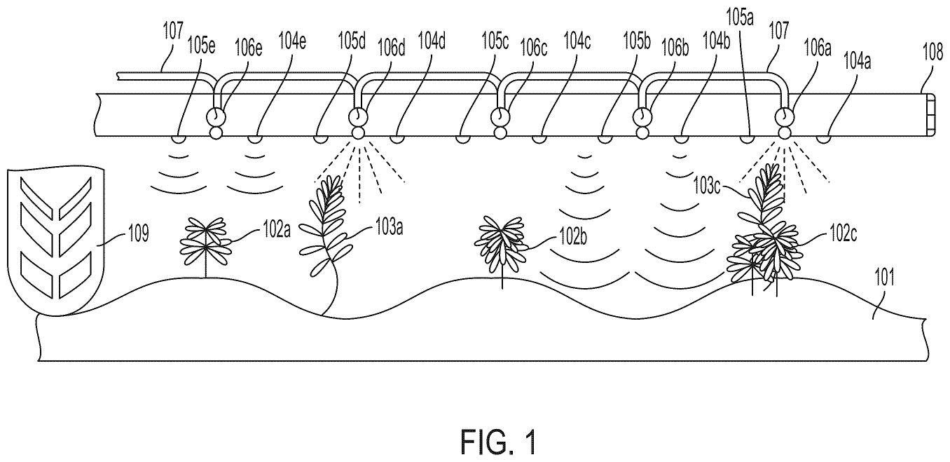

The current disclosure relates to row crop spray apparatus such as shown in FIG. 1. The apparatus is designed to support row crops grown in soil 101 and consisting of plants 102a, 102b, 102c which according to a preferred embodiment include cotton. However, other suitable crops such as corn, lettuce, and tomatoes are contemplated. The apparatus of the present invention is particularly adapted to detect weeds 103a, 103c based on the difference in height between the crop plant 102a, 102b and the weed plant 103a, 103c. Notably, the present invention is capable of distinguishing between weed plants 103c and crop plants 102c based on height difference even where the plants are growing in the same place as shown in FIG. 1.

The apparatus includes an array of first-side ultrasound detectors 104a, 104b, 104c, 104d, 104e, and an array of second-side ultrasound detectors 105a, 105b, 105c, 105d, 105e. Each of the first-side and second-side detectors is positioned on either side of a spray nozzle 106a, 106b, 106c, 106d, 106e. The spray nozzles 106a, 106b, 106c, 106d, 106e are each connected to an herbicide conduit 107 that supplies herbicide to each of the spray nozzles, and are mounted on a boom 108. The boom 108 in a preferred embodiment includes wheels 109 for translating the apparatus over the row crop. In one alternative embodiment, the boom is positioned on a tractor that has been adapted for delivery of herbicide.

In some embodiments the boom 108 has an adjustable height. This may allow for positioning the boom 108 at the time of use at a desired distance above the top of the row crop. Because the crop grows taller throughout the season, it may be necessary to raise the boom to clear the canopy. Because the boom has an adjustable height and is expected to be adjusted throughout the growing season and adjustable when the device is used on different crops having a different height, it may be advantageous to have sensors that are capable of detecting the presence of a plant at a particular height relative to the boom. For example, the if the boom is adjusted higher by three inches, it might be desirable to adjust the sensor depth to be further by three inches to target a plant in the same location. This may be advantageous when a particular weed is known to be present in between row crop plants at a particular height that is much lower than the top of the crop plants.

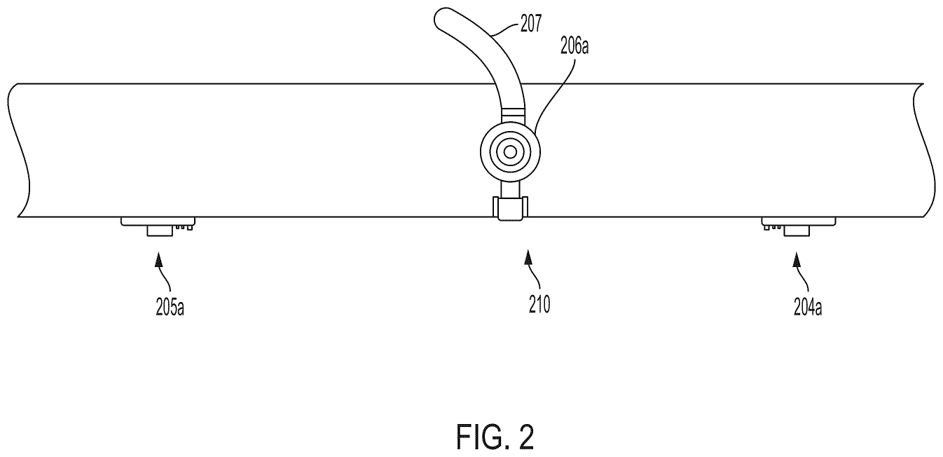

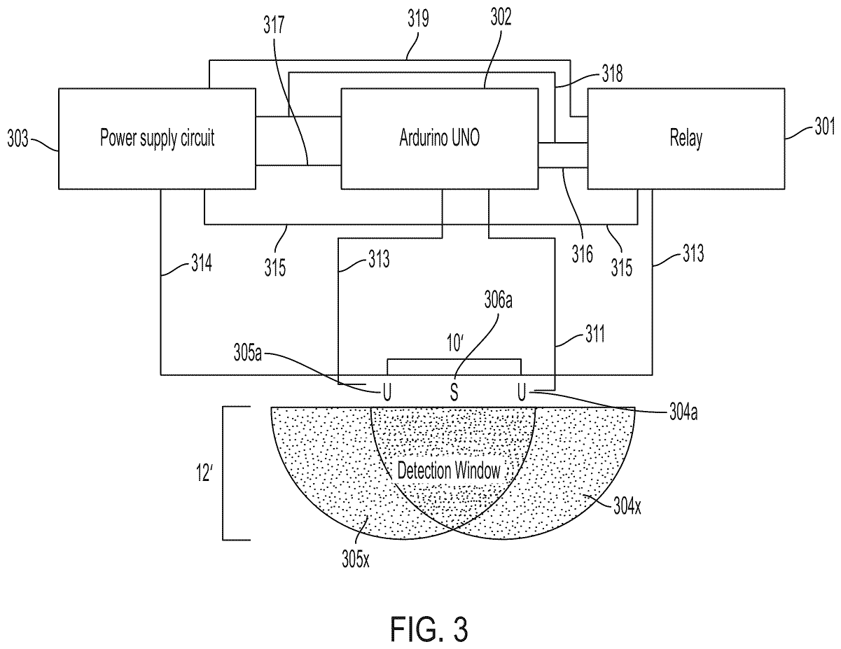

A closer view of the apparatus is shown in FIG. 2. A first-side ultrasound detector 204a is positioned on one side of an herbicide nozzle 206a, and a second-side ultrasound detector 205a is positioned on the other side of the nozzle 206a. The nozzle 206a includes a spray head 210, and is connected at the other end to an herbicide supply conduit 207. The nozzle 206a and ultrasound detectors 204a and 205a are connected to a controller as shown in FIG. 3 below. The distance between each ultrasound detector range from 5 to 15 inches, with 10 inches being preferred. When the distance between detectors is 10 inches the detectors 204a, 204b are preferably spaced evenly 5 inches away from the nozzle 206a. The distance between the detectors may be increased if the height of the detection window is increased. However, the 10 inch distance between detectors is ideal when the detection window is approximately 12 inches.

The control system for the apparatus of the invention includes a relay 301, a controller 302, and a power supply 303 as shown in FIG. 3. The first side detector 304a is electrically connected to the controller 302 through signal wire 311, and the second side detector 305a is connected to the controller 302 through the signal wire 312. It should be appreciated that for an array of detectors, each detector is connected to the controller 302 by way of its own signal wire.

The spray nozzle 306a is connected to the relay 301 via a wire 313, which is typically a 12-volt connection. The spay nozzle is also connected to the power supply through ground wire 314. The relay 301 is also connected to the power supply 303 through a wire 315, which is the same voltage as wire 313, and when the relay is activated supplies power through the relay 301 to the spray nozzle 306a.

The relay 301 receives signal from the controller 302 through signal wire 316. The relay 301 and controller 302 receive power from the power supply 303 through power wire 318. The voltage supplied in the wire 318 may typically be a lower voltage needed to control the electronics of the relay 301 and controller 302, and is typically a 5 volt wire. The relay 301 is grounded to the power supply through ground line 319. The controller 302 is grounded to the power supply 303 through ground wire 317. A person of skill will recognize that grounding may be accomplished through a ground connection to the metallic boom or another part of the apparatus as an alternative to using a grounding wire.

The apparatus constructed in this manner includes overlapping detection windows 304x and 305x. This configuration has been shown particularly effective for distinguishing weeds 103a, 103c from row crop plants 102a, 102b, 102c.

The detection window for an ultrasonic sensor can be varied by the user by setting the time window for receiving the reflection of the ultrasonic wave. The present inventors have found that when ultrasonic detectors are positioned on at least two sides of the spray nozzle, the detection window is preferable for weeds. The individual sensors pairs or groups surrounding each spray nozzle are preferably tuned to the same distance as each other. Detector pairs associated with other spray nozzles on the boom may be tuned to different heights. This can be preferably when alternating nozzles are tuned to target weeds at different heights that are growing in different places. For example, one nozzle/detector group could be tuned to target weeds that exceed the height of the row crop whereas the adjacent nozzle/detector group is turned to target small weeds growing between the row crop plants.

In certain embodiments, the detector pairs may be tuned to detect plants within a window of 12-24″ away from the detector. The distance may be any desired distance between these values, such as for example 12, 16, 17 20, 22, and 24″ from the sensor surface. The present inventors have found that these sensors operate well for weed detection within these ranges. In some cases, adjacent sensor pair may be tuned to operate with different detection windows. For example, one set of detectors could be tuned to detect plants within the range of 12-16″ and adjacent detector pairs could be turned to detect plants within a range of 22-24″ from the detectors.

The device may be arranged such that the sprayer parameters are controlled remotely or by the operator of the tractor in which the spray apparatus is attached, hitched to, or mounted on. For example, the operator may have an electronic control module that communicates with the spray device. The electronic control module may execute a program that communicates with and controls each of the sensors, sprayers, and boom raising or lowering the boom. The program may include coordinated control of the parameters as a group, or individually. For example, the device may be configured to control each sensor pair to set their detection depths in tandem (or as a group). In addition, the device may receive input for a first depth of a first nozzle/detector pairs situated above the top of a row of plants, and a second depth of a second nozzle/detector pairs situated above the area of the row crop between rows of plants.

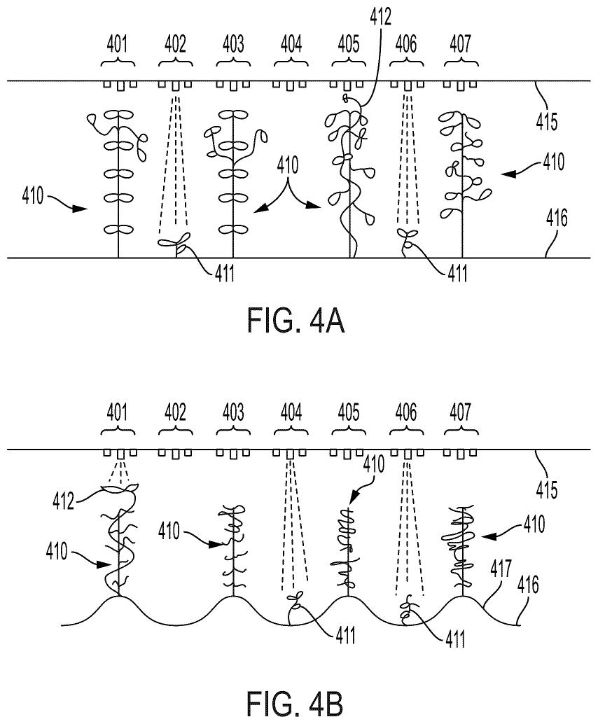

FIG. 4a shows a spray apparatus according to an embodiment of the invention in use where adjacent spray nozzle/detector groups are tuned differently to treat a particular row crop. A first group of nozzle/detectors 401, 403, 405, and 407 are positioned over the plants 410 of the row crop. The first group of nozzle/detectors are configured to spray herbicide when a weed 412 extends above the row crop plants 410. A second group of nozzle/detectors 402, 404, and 406 are positioned in between plants 401 of the row crop. The second group of nozzle detectors 402, 404, and 406 are configured to be triggered by plants 411 growing between the row crops. In the case of FIG. 4A, nozzle/detectors 402, 406, and 405 are shown dispensing herbicide to treat weeds 411 and 412 respectively.

FIG. 4b shows a spray apparatus according to an embodiment of the invention treating a different row crop in which the sensors have been configured to detect weeds growing in trenches between adjacent rows of soil 417. The ability to independently tune nozzle/detector groups allows for a range of versatility in the crop conditions treated.

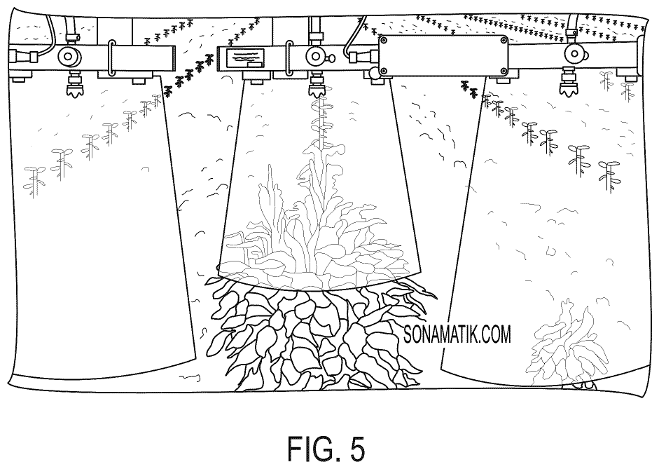

These detection windows may also be adjusted depending on the height of the bar in which the detectors are attached. In one preferred embodiment, the adjacent detector/nozzle groups are configured to spray weeds of various heights depending on where they occur. For example, detector/nozzle groups positioned above the row crops could be configured to spray any plants exceeding the height of the row crop, while detector/nozzle groups positioned between row crops may be configured to spray plants of any height growing between the row crops as shown in FIG. 5.

Other embodiments and uses of the invention will be apparent to those skilled in the art from consideration of the specification and practice of the invention disclosed herein. All references cited herein, including all U.S. and foreign patents and patent applications, are specifically and entirely hereby incorporated herein by reference. It is intended that the specification and examples be considered exemplary only, with the true scope and spirit of the invention indicated by the following claims.

What is claimed is:

1. An apparatus for application of herbicide to a row crop comprising:
a pair of wheels for translating the apparatus over the row crop that when in use are aligned with the direction of each of a plurality of rows of the row crop;
an array of ultrasound detector pairs arranged perpendicular to the pair of wheels that when is use are aligned perpendicular to the direction of each of the plurality of rows of the row crop;
each ultrasound detector pair comprising:
a first ultrasound detector in electrical communication with a controller, the first ultrasound detector being capable of detecting a plant within a first predetermined distance range from the sensor;
a second ultrasound detector in electrical communication with the controller, the second ultrasound detector being capable of detecting a plant within a second predetermined distance range from the sensor;
a spray nozzle, the spray nozzle being positioned between the first ultrasound detector and second ultrasound detector, the spray nozzle being connected to the controller, wherein the spray nozzle is activated through a signal from the controller that is based on detection of a weed by the first ultrasound detector and/or second ultrasound detector.

2. The apparatus of claim 1, further comprising a first power supply line connecting a power supply to a relay, and a second power supply line connecting the relay to the spray nozzle.

3. The apparatus of claim 2, further comprising a third power supply line connecting a power supply with the controller and the relay.

4. The apparatus of claim 1, further comprising a first signal wire connecting the first ultrasound detector to the controller, and a second signal wire connecting the second ultrasound detector to the controller.

5. The apparatus of claim 1, wherein the first predetermined distance range and the second predetermined distance range are the same.

6. The apparatus of claim 1, wherein the first predetermined distance range and second predetermined distance ranges are from 12 inches to 24 inches away from the first sensor and second sensor respectively.

7. The apparatus of claim 1, further comprising
a third ultrasound detector in electrical communication with a controller, the third ultrasound detector being capable of detecting a plant within a third predetermined distance range from the sensor;
a fourth ultrasound detector in electrical communication with the controller, the fourth ultrasound detector being capable of detecting a plant within a fourth predetermined distance range from the sensor;
a second spray nozzle, the second spray nozzle being positioned between the third ultrasound detector and fourth ultrasound detector, the second spray nozzle being connected to the controller, wherein the second spray nozzle is activated through a signal from the controller that is based on detection of a weed by the third ultrasound detector and/or fourth ultrasound detector.

8. The apparatus of claim 7, wherein the third predetermined distance range and the fourth predetermined distance range are the same.

9. The apparatus of claim 8, wherein the third predetermined distance range and fourth predetermined distance ranges are from 6 inches to 12 inches away from the first sensor and second sensor respectively.

10. The apparatus of claim 9, wherein the first nozzle and second nozzle are arranged to be adjacent to each other and the first nozzle during use is positioned between the row crop plants, and the second nozzle is positioned above the row crop plants.

11. A method for application of herbicide to a row crop comprising:
moving an apparatus over a plurality of rows of the row crop, the apparatus comprising:
a pair of wheels for translating the apparatus over the row crop that when in use are aligned with the direction of each of a plurality of rows of the row crop;
an array of ultrasound detector pairs arranged perpendicular to the pair of wheels that when is use are aligned perpendicular to the direction of each of the plurality of rows of the row crop;
each ultrasound detector pair comprising:
a first ultrasound detector in electrical communication with a controller, the first ultrasound detector being capable of detecting a plant within a first predetermined distance range from the sensor;
a second ultrasound detector in electrical communication with the controller, the second ultrasound detector being capable of detecting a plant within a second predetermined distance range from the sensor;
a spray nozzle, the spray nozzle being positioned between the first ultrasound detector and second ultrasound detector, the spray nozzle being connected to the controller;
activating the spray nozzle through a signal from the controller when a weed is detected by the first ultrasound detector and/or second ultrasound detector.

12. The method of claim 11, further comprising a first power supply line connecting a power supply to a relay, and a second power supply line connecting the relay to the spray nozzle.

13. The method of claim 12, further comprising a second power supply line connecting a power supply with the controller and the relay.

14. The method of claim 11, further comprising a first signal wire connecting the first ultrasound detector to the controller, and a second signal wire connecting the second ultrasound detector to the controller.

15. The method of claim 11, wherein the first predetermined distance range and the second predetermined distance range are the same.

16. The method of claim 11, wherein the first predetermined distance range and second predetermined distance ranges cover a detection window that would be triggered upon the detection of a plant having a range of heights, including heights that exceed the height of the row crop plants.

17. The method of claim 11, further comprising
a third ultrasound detector in electrical communication with a controller, the third ultrasound detector being capable of detecting a plant within a third predetermined distance range from the sensor;
a fourth ultrasound detector in electrical communication with the controller, the fourth ultrasound detector being capable of detecting a plant within a fourth predetermined distance range from the sensor;
a second spray nozzle, the second spray nozzle being positioned between the third ultrasound detector and fourth ultrasound detector, the second spray nozzle being connected to the controller, wherein the second spray nozzle is activated through a signal from the controller that is based on detection of a weed by the third ultrasound detector and/or fourth ultrasound detector.

18. The method of claim 17, wherein the third predetermined distance range and the fourth predetermined distance range are the same.

19. The method of claim 18, wherein the third predetermined distance range and fourth predetermined distance ranges are set to be equivalent to the distance between the sensor height above the crop, such that any weeds rising above the top of the crop trigger the second spray nozzle.

20. The method of claim 19, wherein the first nozzle and second nozzle are arranged to be adjacent to each other and the first nozzle during use is positioned between the row crop plants, and the second nozzle is positioned above the row crop plants.
